(19) United States
(12) Patent Application Publication
(10) Pub. No.: US 2015/0040042 A1
(43) Pub. Date: Feb. 5, 2015

(54) ELECTRONIC DEVICE AND METHOD FOR DISPLAYING USER INTERFACE

(71) Applicant: ACER INCORPORATED, NEW TAIPEI CITY (TW)

(72) Inventors: Wei-Ying Huang, New Taipei City (TW); Ting-Feng Chou, New Taipei City (TW)

(73) Assignee: ACER INCORPORATED, NEW TAIPEI CITY (TW)

(21) Appl. No.: 14/084,079

(22) Filed: Nov. 19, 2013

(30) Foreign Application Priority Data
Aug. 1, 2013 (TW) 102127573

(51) Int. Cl. G06F 3/0484; G06F 3/0481; G06F 3/0488

(52) U.S. Cl. CPC G06F 3/04847; G06F 3/0488; G06F 3/04817
USPC 715/762

(57) ABSTRACT

An electronic device for digital notebook includes a display unit, a touching unit, a processing unit and a storage unit. The display unit displays a digital notebook which includes an edited area in a predetermined area. The touching unit receives a touch signal. The processing unit increases the size of the edited area based on a proportion from an original size to a first size according to the touch signal, and compresses the size of the edited area from the first size to the original size, that is, a first resolution corresponding to the first size will be decreased to a second resolution corresponding to the original size. The storage unit stores the digital notebook according to a storing signal. The display unit displays the note content of the digital notebook corresponding to the original size after storing.

### CROSS REFERENCE TO RELATED APPLICATIONS

This application claims priority of Taiwan Patent Application No. 102127573, filed on Aug. 1, 2013, the entirety of which is incorporated by reference herein.

### BACKGROUND OF THE INVENTION

1. Field of the Invention

The application relates in general to an electronic device and a method for displaying a user interface, and in particular, to a method for changing the size of edited areas of a digital notebook according to a touch signal.

2. Description of the Related Art

These days, intelligent electronic devices are widely used by users to make note of the important things by using software which has a annotation or note function. However, when users are in a situation in which the edited area of the digital notebook is insufficient to finish recording the content, the only way to continue editing is to change to the next line or page, causing an inconvenience when reading the content of the note or using the device. Thus, how to provide a better experience for users in that situation is the problem which needs to be solved immediately.

### BRIEF SUMMARY OF INVENTION

An embodiment of the invention provides an electronic device, including a display unit, a control unit, a processing unit and a storage unit. The display unit displays a digital notebook which comprises an edited area in a predetermined area. The touching unit receives a touch signal. The processing unit increases the size of the edited area based on a proportion from an original size to a first size according to the touch signal, and compresses the size of the note content of the edited area from the first size to the original size, that is, a first resolution corresponding to the first size will be decreased to a second resolution corresponding to the original size. The storage unit stores the digital notebook according to a storing signal. Wherein, the display unit displays the note content of the digital notebook corresponding to the original size after storing.

Another embodiment of the invention provides a method for displaying a user interface. The steps of the method comprise displaying a digital notebook which comprises an edited area in a predetermined area; receiving a touch signal; increasing the size of the note content of the edited area based on a proportion from the original size to the first size; receiving the storing signal; compressing the size of the edited area from the first size to the original size, wherein a first resolution corresponding to the first size will be decreased to the second resolution corresponding to the original size; storing the note content of the digital notebook; displaying the note content of the digital notebook.

### BRIEF DESCRIPTION OF DRAWINGS

The invention can be more fully understood by reading the subsequent detailed description and examples with references made to the accompanying drawings, wherein:

FIG. 1 is a block diagram of an electronic device in accordance with an embodiment of the invention;

FIG. 2 is a scheme of a digital notebook in accordance with an embodiment of the invention;

FIG. 3A, 3B are schemes for increasing the size of the edited area according to a touch signal in accordance with an embodiment of the invention;

FIG. 4A, 4B are schemes for compressing the size of the edited area according to a storing signal in accordance with an embodiment of the invention; and

FIG. 5 is a flow chart of a method for displaying a user interface in accordance with an embodiment of the invention.

### DETAILED DESCRIPTION OF INVENTION

Further areas of applicability of the present devices and methods will become apparent from the detailed description provided hereinafter. It should be understood that the detailed description and specific examples, while indicating exemplary embodiments of the devices and methods, are intended for purposes of illustration only and are not intended to limit the scope of the invention.

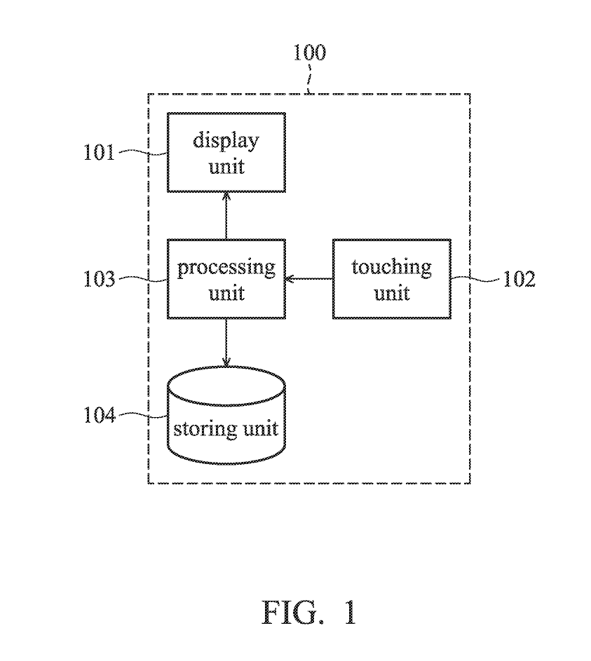

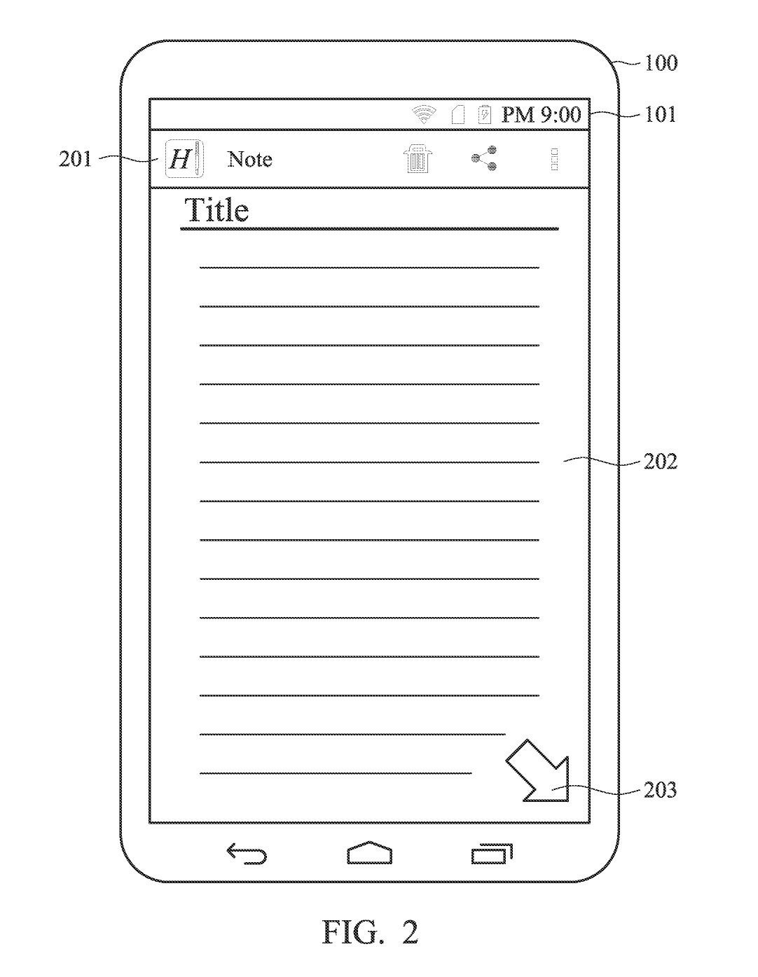

FIG. 1 is a block diagram of an electronic device in accordance with an embodiment of the invention. As shown in FIG. 1, an electronic device 100 includes a display unit 101, a touching unit 102, a processing unit 103 and a storage unit 104. As shown in FIG. 2, the display unit 101 displays a digital notebook 201 which comprises an edited area 202 in a predetermined area. The touching unit 102 receives a touch signal. The processing unit 103 couples to the touching unit 102 and increases the size of edited area by receiving the touch signal.

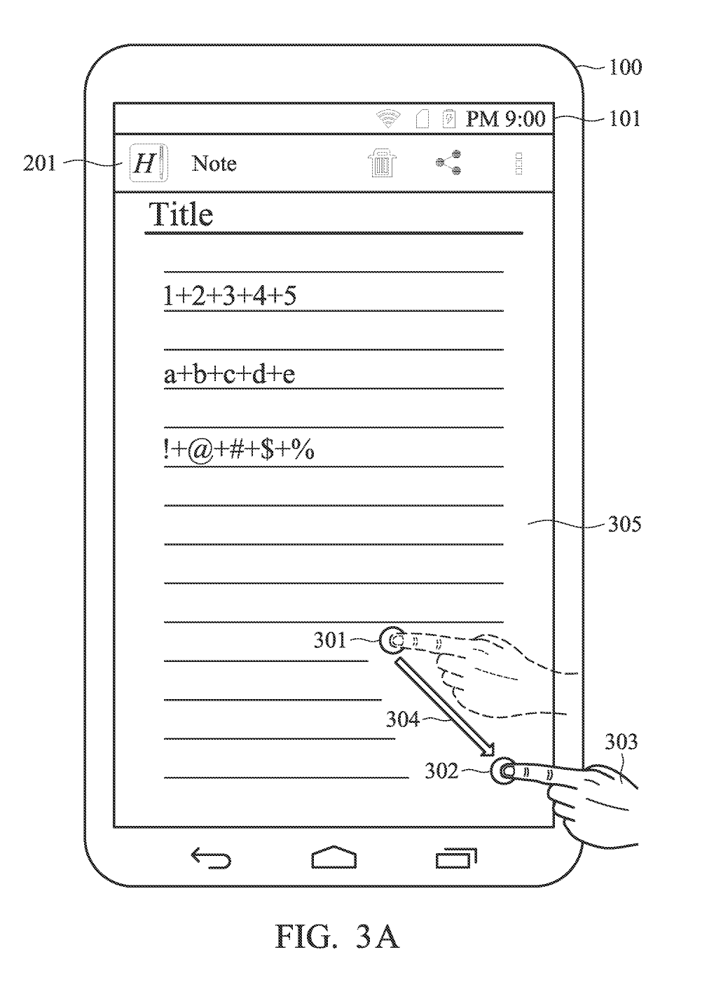

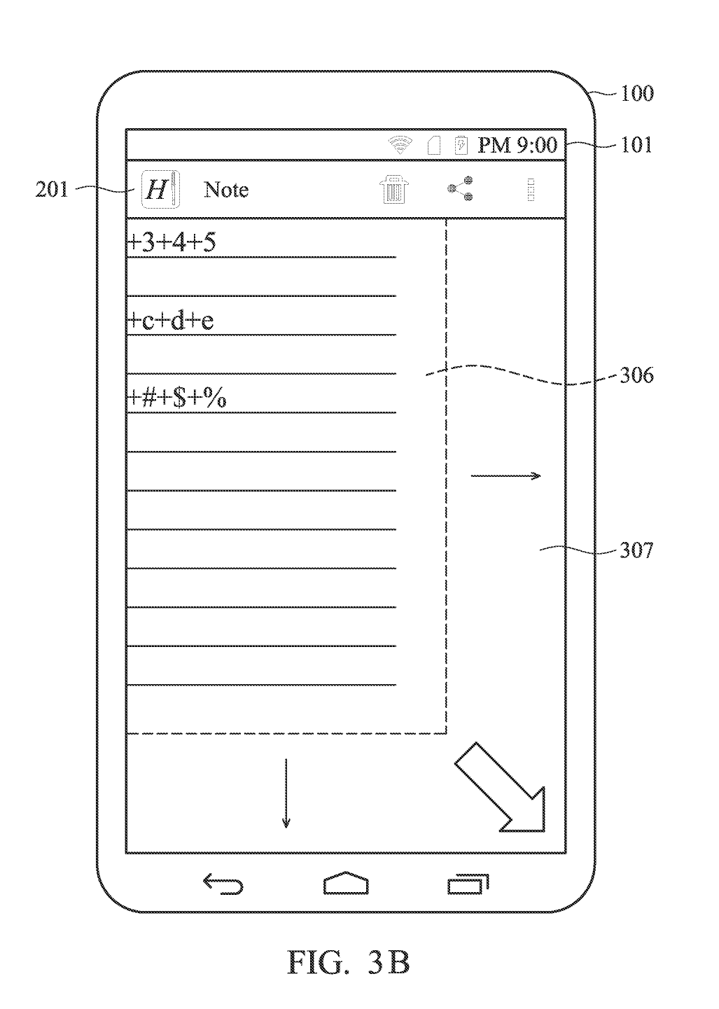

In accordance with an embodiment of the invention, the touch signal can be a touching gesture. As shown in FIG. 3, the processing unit 103 increases the size of the edited area according to the touching gesture when a hand (or a stylus) 303 slides from point 301 to point 302. For example, the original size of edited area is 600*800, and the first size of the increased edited area is 900*1200. The scale can be set by users. For instance, the scale can be determined according to the distance of the touching gesture, such as distance 304 shown in FIG. 3A, or it can be set at a predetermined scale, e.g. a scale of 20% for each touching gesture. It should be noted that section 306 only shows a portion of the content noted in the edited area 305 corresponding to the original size, and section 307 is corresponding to portion of edited area which has the first size.

In accordance with another embodiment of the invention, whether the touch signal is corresponding to an icon 203 (as shown in FIG. 2) or not can be determined by the processing unit 103. If the processing unit 103 detects a touch signal corresponding to the icon 203, then increases the size of the edited area according to the touch signal. After that, the implementation of increasing the size of the edited area is the same as that described above, thus the related description has been bypassed.

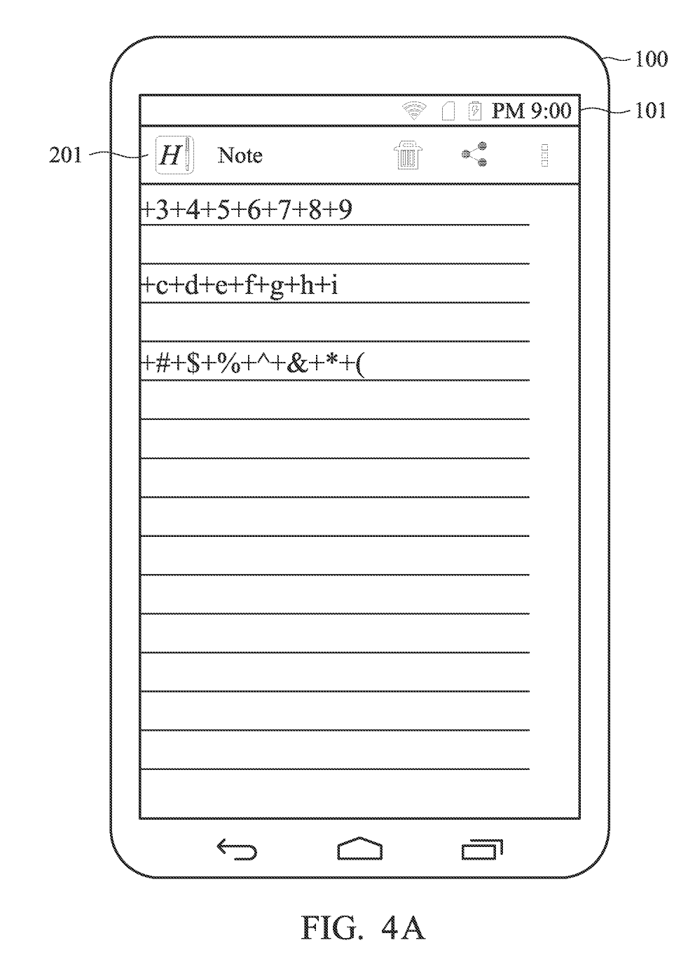

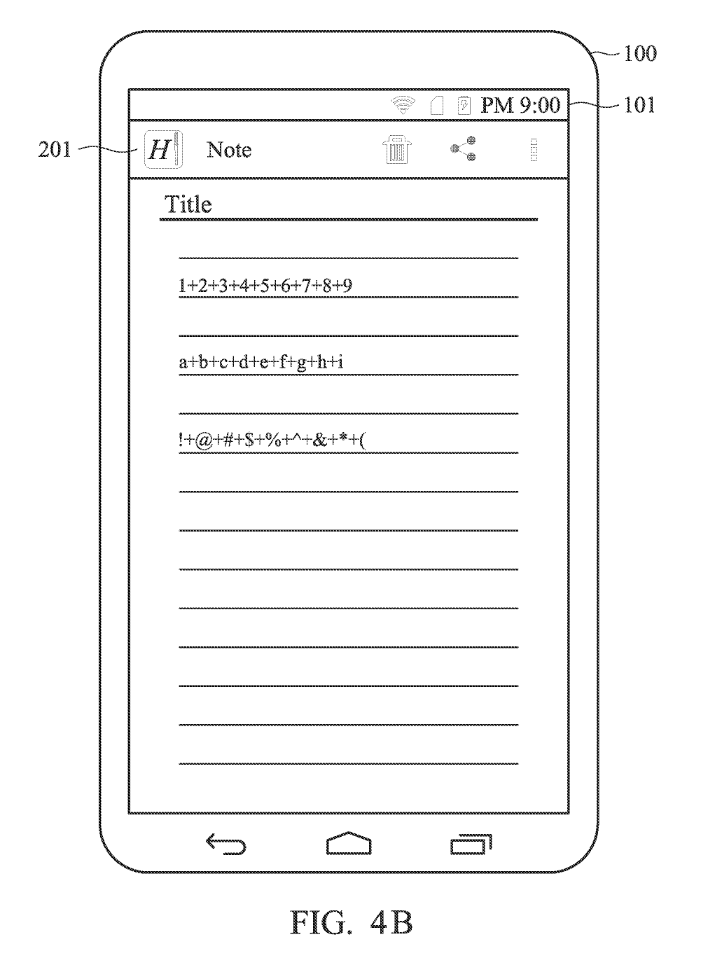

Please refer to FIG. 4. After users finish editing a note, a storing signal will be sent to the processing unit 103, and the processing unit 103 will compress the size of the edited area based on the scale from the first size to the original size. For example, after increasing, the first size can be 900*1200, then after finishing, the content will be compressed from the first size to 600*800 according to the scale. As show in FIG. 4A, the resolution before compressed is the same as the original resolution of the edited area corresponding to the original size. FIG. 4B shows the note content which has been compressed to the second resolution corresponding to the original size. As shown in FIG. 4B, the second resolution corresponding to the original size is lower than the first resolution corresponding to the first size. Wherein, after storing the digital notebook by the storing unit 104, the display unit 101 displays the note content with the second resolution corresponding to the original size.

It should be noted that users can set a predetermined size before performing step S504 to avoid the problem of the resolution of the note content shown in the edited area being too low to read because of the compression corresponding to the original size. For example, after setting a predetermined size of 1200*1600, even though the processing unit 103 has repeatedly received the touch signal, the size of the edited area will not be increased.

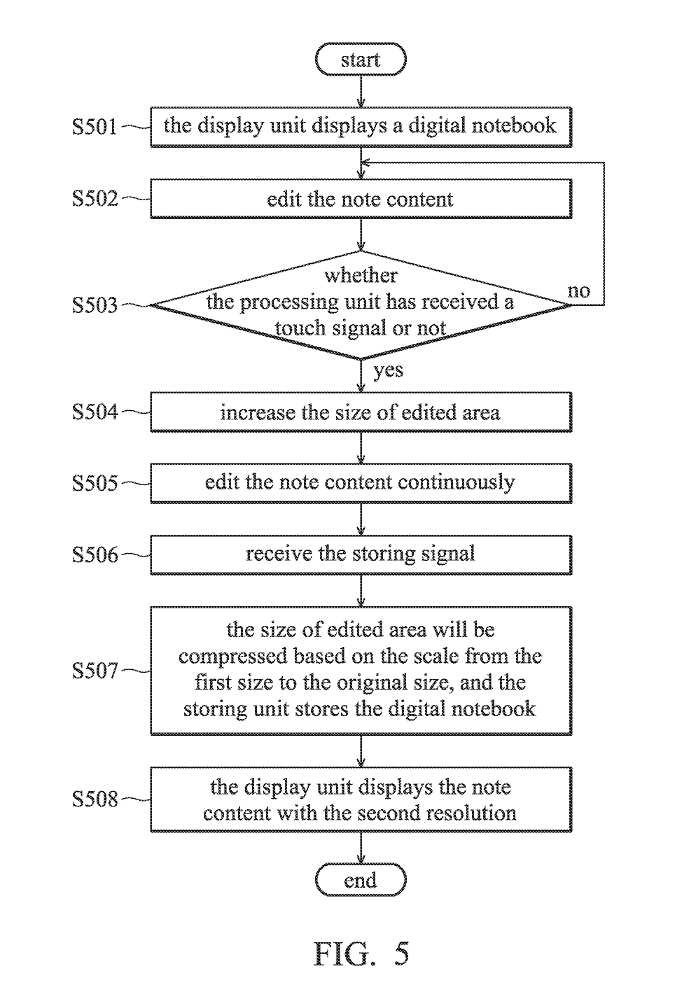

Please refer to FIG. 5. FIG. 5 is a flow chart of a method for displaying a user interface in accordance with an embodiment of the invention. At step S501 (please refer to FIG. 2), the display unit 101 displays a digital notebook 201 which comprises an edited area 202 in a predetermined area. Users edit the note content in edited area 202 (step S502). However, when the recorded note content is too much to record in the original edited area 202, users will enable a touching gesture. At step S503, the processing unit 103 judges whether it has received a touch signal or not. If it has received the touch signal accurately, then step S504, and increases the size of edited area according to the touch signal.

In accordance with an embodiment of the invention, the touch signal can be a touching gesture. Please refer to FIG. 3. The processing unit 103 increases the size of the edited area according to the touching gesture when a hand (or a stylus) 303 slides from point 301 to point 302. As shown in FIG. 3B, the size of the edited area increases from the original size to the first size, the area 306 shown the increased edited area displayed in the display unit 101. For example, the original size of edited area is 600*800, and the first size of the increased edited area is 900*1200. The scale can be set by users. For instance, the scale can be determined according to the distance of the touching gesture such as distance 304 shown in FIG. 3A, or it can be set at a predetermined scale, e.g. a scale of 20% for each touching gesture. It should be noted that, section 306 only shows portion of content noted in the edited area 305 corresponding to the original size, and section 307 is corresponding to portion of edited area which has the first size.

In accordance with another embodiment of the invention, whether the touch signal is corresponding to an icon 203 (as shown in FIG. 2) or not can be determined by the processing unit 103. If the processing unit 103 detects a touch signal corresponding to the icon 203, then it increases the size of the edited area according to the touch signal. After that, the implementation of increasing the size of the edited area is the same as that described above, thus the related description has been bypassed.

Users can edit the note content continuously after increasing the size of the edited area (step S505). When finished editing, users then triggers a storing signal. After receiving the storing signal by the processing unit 103 (step S506), the size of edited area will be compressed based on the scale from the first size to the original size (step S507). For example, after increasing, the first size can be 900*1200, then after finishing, the first size will be compressed to scale with the content to 600*800. Please refer to FIG. 4. As shown in FIG. 4A, the resolution before compressing is same as the original resolution of the edited area corresponding to the original size. FIG. 4B shows the note content which has been compressed to the second resolution corresponding to the original size. As shown in FIG. 4B, the second resolution corresponding to the original size is lower than the first resolution corresponding to the first size.

Back to step S508, after storing the digital notebook by the storing unit 104, the display unit 101 displays the note content with the second resolution corresponding to the original size.

It should be noted that, users can set a predetermined size before performing step S504 to avoid the problem of the resolution of the note content shown in the edited area being too low to read because of the compression corresponding to the original size. For example, setting a predetermined size which is 1200*1600, even though the processing unit 103 has received the touch signal repeatedly, the size of the edited area will not be increased.

An embodiment of the invention provides an electronic device and a method for displaying a user interface. In a situation in which the content which users want to edit is too much, the size of the edited area can be increased appropriately for adding the content which is not finished yet into the edited area. In this way, the inconvenience of changing the line or page when editing can be avoided and the convenience of reading the content of the note can also be increased.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. An electronic device, comprising:
a display unit, displaying a digital notebook having an edited area in a predetermined area;
a touching unit, receiving a touch signal;
a processing unit, increasing a size of the edited area based on a scale from an original size to a first size according to the touch signal, compressing the size of the edited area from the first size to the original size, and decreasing resolution of note content of the edited area from a first resolution corresponding to the first size to a second resolution corresponding to the original size; and
a storage unit, storing the digital notebook according to a storing signal;
wherein the display unit displays the content corresponding to the original size after storing the digital notebook by the storing unit.

2. The electronic device as claimed in claim 1, wherein the touch signal further comprises a touching gesture, and the size of the edited area increases from the original size to the first size according to the touching gesture.

3. The electronic device as claimed in claim 1, wherein the display unit further displays an icon, and the processing unit further judges whether the touch signal is corresponds to the icon or not, and increases the size from the original size to the first size according to the touch signal.

4. The electronic device as claimed in claim 1, wherein the processing unit further comprises a predetermined size, and the first size is less than or the same as the predetermined size.

5. The electronic device as claimed in claim 1, wherein the display unit only displays a portion of the note content corresponding to the first size, and the processing unit further changes the arrangement of the content according to the touch signal.

6. A method for displaying user interface, comprising:
displaying a digital notebook which comprises an edited area in a predetermined area;
receiving a touch signal;
increasing the size of the edited area based on a scale from an original size to a first size;
receiving a storing signal;
compressing the size of note content of the edited area from the first size to the original size, wherein a first resolution corresponding to the first size will be decreased to a second resolution corresponding to the original size;
storing the digital notebook; and
displaying the note content of the digital notebook.

7. The method as claimed in claim 6, wherein the touch signal further comprises a touching gesture, and the size of the edited area increases from the original size to the first size according to the touching gesture.

8. The method as claimed in claim 6, wherein a display unit displays an icon, and a processing unit judges whether the touch signal is corresponding to the icon or not, and increases the size from the original size to the first size according to the touch signal.

9. The method as claimed in claim 6, wherein the first size is less than or the same as a predetermined size.

10. The method as claimed in claim 6, wherein a display unit only displays a portion of the note content corresponding to the first size, and the touch signal is further used to change the arrangement of the content.
